(19) United States
(12) Patent Application Publication
(10) Pub. No.: US 2020/0343569 A1
(43) Pub. Date: Oct. 29, 2020

(54) PROTON EXCHANGE MEMBRANE WITH ENHANCED CHEMICAL STABILITY AND METHOD OF PREPARING THEREOF

(71) Applicant: Tianjin University, Tianjin (CN)

(72) Inventors: Yan YIN, Tianjin (CN); Junfeng ZHANG, Tianjin (CN); Xin LIU, Tianjin (CN); Michael Dominic GUIVER, Tianjin (CN)

(73) Assignee: Tianjin University, Tianjin (CN)

(21) Appl. No.: 16/690,139

(22) Filed: Nov. 21, 2019

(30) Foreign Application Priority Data
Apr. 29, 2019 (CN) 201910355411.5

(51) Int. Cl. H01M 8/1051; H01M 8/1023; H01M 8/1039; H01M 8/1025; H01M 8/1032; H01M 8/1072; C08J 5/22

(52) U.S. Cl. CPC H01M 8/1051; H01M 8/1023; H01M 8/1039; H01M 8/1025; H01M 8/1032; H01M 2008/1095; C08J 5/2293; C08J 5/225; C08J 5/2287; C08J 5/2256; H01M 8/1072

(57) ABSTRACT

polymeric ion-conducting membrane with an enhanced stability against attacks of free radicals for exteding its service time, which comprises (a) a polymer matrix, and (b) a redox stabilizer, where the redox stabilizer is attached to the polymer matrix by chemical or ligand bonding, or the redox stabilizer is physically mixed with the polymer matrix.

### FIELD OF THE INVENTION

The present invention relates to a proton exchange membrane with enhanced chemical stability and method of preparing the proton exchange membrane.

### BACKGROUND OF THE INVENTION

As a core component of proton exchange membrane fuel cells, the proton exchange membrane separates the anode and cathode, and concurrently conducts protons and obstruct electrons, playing a pivotal role to the overall performance of the fuel cell. At present, some commercialized proton exchange membranes, such as Nafion-type perfluorosulfonic acid polymers, have achieved the fundamental requirement on ion conductivity for use in fuel cells. However, during in situ operations of fuel cells, proton exchange membranes are subjected to complex conditions which combine membrane water content and diffusion, heat, mechanical stresses, proton and other ion species conductivity, electrochemical processes, free radical and radical ion species and their degradative chemical reactions with the surrounding matrix. Thus, thermal, mechanical and chemical degradation are prone to take place, particularly under conditions which exacerbate it, such as an elevated temperature and reduced relative humidity, so the fuel cell membrane durability is a long-standing challenge.

Among the possible types of degradation of proton exchange membranes, chemical degradation refers to the damage of membrane materials caused by attack from free radicals such as .OH and .OOH. Free radical induced degradation is responsible for the majority of the overall degradation, and extensive efforts have been focused on mitigating this degradation, which is more evident at elevated temperatures and in low humidity environments. Until now, the most widely used strategy to improve the chemical stability of proton exchange membranes is the incorporation of free radical decomposition catalysts based on transition metal ions. For example, cerium ions impart some limited enhancement in stability against free radical attack, but the single metal ions are prone to migrate through the membrane. Other methods include incorporation of small molecular antioxidants and heteropolyacids. Although enhancements in the chemical stability of proton exchange membranes have been achieved, their beneficial stabilizing effects are not so far significant t, and there is no clear theoretical or in-depth understanding of their mode of action. Thus, there remains a need for proton exchange membranes with enhanced chemical stability and longer service life.

### SUMMARY OF THE INVENTION

The object of the present invention is to solve the technical problem that proton exchange membranes used in fuel cells have a short service life, and the object is realized by a novel method to prepare proton exchange membranes, which are perfluorinated, partially fluorinated, hydrocarbon-based membranes, and heteroatom-containing polymers. The essence of the method is the incorporation of a chemical redox stabilizer into ion exchange membranes. Here, a chemical redox stabilizer is defined as an inorganic or organic chemical compound capable of readily interchanging between two or more oxidation states by loss or gain of electrons. Specifically excluded are simple multivalent metal salts, such as those derived from vanadium or cerium, which are capable of interchanging oxidation states by loss or gain of electrons, but are unsuitable for the present invention, since they may easily migrate or leach out of the membrane. More specifically, a negatively charged ferrocyanide or ferricyanide group is introduced into proton exchange membranes, which can continuously scavenge free radicals as they are generated during electrochemical operation (mainly .OH and .OOH radicals), thus affording proton exchange membranes with high chemical stability and good durability under a variety of electrochemical operating conditions.

The technical solution provided by the present invention is summarized as follows:

A method for preparing a proton exchange membrane with enhanced chemical stability comprises the following steps:
(1) preparing a polymer matrix capable of membrane formation by solution casting;
(2) physically mixing the polymer matrix with inorganic redox stabilizer molecules to prepare a membrane casting formulation, [or alternatively bonding or substituting the redox molecule by ligand substitution reaction between the ferrocyanide or ferricyanide group with a polymer matrix, and using alone as a membrane formulation];
(3) dissolving the mixture prepared in step (2) in a solvent to prepare a membrane casting solution with a total concentration of 10-500 g/L, and leaving the solution to stand for defoaming;
(4) decanting the membrane casting solution into a casting dish, and evaporating the solvent for 12-48 h at a temperature of 20-160° C. under ambient or reduced pressure to form a membrane; and
(5) after the above membrane formation process completed, performing acidification treatment to the membrane in an ice bath, to obtain a proton exchange membrane with improved chemical stability.

Preferably, the polymer matrix in step (1) is a perfluorinated polymer, a partially fluorinated polymer, or a hydrocarbon or a heteroatom-containing ion conducting polymer, which is selected from the group consisting of Nafion or similar commercially available perfluorinated polymers (e.g. Aquivion), sulfonated poly(ether ether ketone)s or copolymers containing these units, sulfonated polysulfones or copolymers containing these units, sulfonated poly(ether sulfone)s or copolymers containing these units, sulfonated poly(aryl sulfide sulfone)s or copolymers containing these units, sulfonated polyimides or copolymers containing these units, sulfonated polystyrenes or copolymers containing these units, sulfonated poly(aryl ether nitrile)s or copolymers containing these units, sulfonated poly(aryl sulfide)s or copolymers containing these units, poly(vinyl pyridine), poly(vinyl chloride), and copolymers of vinylidene fluoride and hexafluoropropylene. The preferred polymer matrices may also have modified architecture, such as side chains, functional group-containing side chains, or may be crosslinked. The selection of suitable raw materials and methods for preparing the polymer matrix are generally known to people of ordinary skill in the art.

Preferably, examples the inorganic redox stabilizer molecules used in step (2) are a ferricyanide or a ferricyanide group, which for example, may be selected from the group consisting of potassium ferrocyanide, sodium ferrocyanide, ammonium ferrocyanide, potassium ferricyanide, sodium ferricyanide, ammonium ferricyanide, hexacyanoferrous acid, hexacyanoferric acid, potassium nitroprusside, sodium nitroprusside. The aforementioned compounds are examples only and a person of ordinary skill in the art may, based on the principle of the present invention, find other compounds also suitable to be used as suitable redox stabilizer molecules in practicing the present invention.

Alternatively, step (2) may also be carried out to apply the redox stabilizer by chemical or ligand bonding, instead of applied by physical mixing with the polymer ingredients of the polymer matrix as described above. A ligand substitution reaction between the ferrocyanide or ferricyanide group with a polymer component of the matrix is carried out to directly attach the ferrocyanide or ferricyanide group to the molecules of the polymer components. The inorganic redox stabilizer molecules applied in this way may be selected, by way of example, not limitation, from the group consisting of sodium pentacyanoammineferroate and ammonium disodium pentacy anoammineferroate.

It is also understood that more than one types of redox stabilizers may be used in the membrane according to the present invention.

The preferred examples given do not limit the scope of the intention, which serve to demonstrate the utility of the invention. The principles can equally be applied to any ion conducting polymer, either anion exchange or cation or proton exchange polymeric materials of sufficiently high molecular weight to prepare membranes of sufficient mechanical integrity, for use in an electrochemical operating system where free radial or radical ion degradative species are generated during the natural course of operation, and where the redox stabilizing agent is either mixed or chemically attached to the ion conducting polymer. Examples of applications employing ion exchange membranes operating in electrochemical environments where free radical or radical ion species may be generated that would result in membrane degradation include fuel cells, electrolysis, and electrodialysis.

Preferably, when the polymer matrix in step (2) is physically mixed with the redox material containing a ferricyanide or a ferricyanide group, the mass ratio of matrix/additive is (99-85):(1-15); and in the case of chemical or ligand bonding between a polymer matrix and a redox stabilizer containing the ferrocyanide or ferricyanide group is formulated, the proportion of the segment containing the redox material ferrocyanide or ferricyanide in the modified material is from 1% to 70%.

Preferably, the solvent in step (3) is one selected from the group consisting of dimethylformamide, dimethylacetamide, N-methylpyrrolidone, dimethyl sulfoxide, m-cresol, tetrahydrofuran, and methanol.

The present invention demonstrates the following beneficial effects:

The preparation method of a proton exchange membrane with chemical stability provided by the present invention has a wide range of applicable raw materials, a simple preparation process, and mild treatment conditions.

Compared with the conventional membrane preparation method, the present invention introduces a negative charged ferricyanide or a ferricyanide group into a proton exchange membrane, to continuously scavenge free radicals (mainly OH. and OOH.) during a fuel cell operation process, thereby imparting much improved chemical stability to the proton exchange membrane.

Both of the free radicals OH. and OOH. contain unpaired electrons, and thus both have high electrophilicity. Any negatively charged areas in a proton exchange membrane structure is thus more readily attacked by OH. and OOH.. Existing research and knowledge indicate that carboxyl groups, a sulfonic groups, or ether linkages in proton exchange membranes are generally more sensitive to OH. and OOH. attack. Therefore, a negative charged redox reagent such as ferricyanide or ferricyanide introduced into proton exchange membranes can continuously scavenge free radicals generated in the system during electrochemical operation of the fuel cell, thereby significantly improving the chemical stability of the proton exchange membrane, so that the durability of proton exchange membranes in actual fuel cell operation are greatly improved.

It is understood that the redox stabilizer according to the present invention may also be a quinone-based molecule that may undergo redox cycle, such as hydroquinone, benzoquinone, naphthoquinone, phenanthraquinone, anthraquinone and all their related derivatives.

It is understood that the redox stabilizer may not only be based on a ferrocyanide or a ferricyanide group. Other types may also be used, for example, a quinone-based molecule that may undergo redox cycle, such as hydroquinone, benzoquinone, naphthoquinone, phenanthraquinone, anthraquinone and all their related derivatives.

### BRIEF DESCRIPTION OF DRAWINGS

FIG. 1 shows the change of the open circuit voltage value of a proton exchange membrane (Nafion-Redox) prepared in the embodiment 1 and a comparative proton exchange membrane (recast Nafion) prepared similarly by using only a commercial Nafion solute, tested over time in the absence of operating current of the fuel cell. It is comparative OCV curves of the PEMFCs based on recast commercial Nafion membrane and Nafion membrane with redox stabilizer. The Nafion membrane with redox stabilizer shows a large improvement in stability under conditions of 90° C. and 30% RH.

FIG. 2 shows the change of the open circuit voltage value of a proton exchange membrane (SPEEK-Redox) prepared in the embodiment 2 and a proton exchange membrane (SPEEK) prepared by using only a sulfonated poly(ether ether ketone) with a 70% degree of sulfonation, tested over time in the absence of operating current of the fuel cell. It is comparative OCV curves of the PEMFCs based on SPEEK membrane with 70% degree of sulfonation and SPEEK membrane with redox stabilizer. The SPEEK membrane with redox stabilizer shows a large improvement in stability under conditions of 90° C. and 30% RH.

FIG. 3 shows the change of the open circuit voltage value of a proton exchange membrane (SPSf-Redox) prepared in the embodiment 3 and a proton exchange membrane (SPSf) prepared by using only a sulfonated polysulfone, tested over time in the absence of operating current of the fuel cell. It is comparative OCV curves of the PEMFCs based on commercial SPSf membrane with 40% degree of sulfonation and SPSf membrane with redox stabilizer. The SPSf membrane with redox stabilizer shows a large improvement in stability under conditions of 90° C. and 30% RH.

FIG. 4 shows Comparative OCV curves of the PEMFCs based on FC2178 membrane and FC2178 membrane with redox stabilizer. The FC2178 membrane with redox stabilizer shows a large improvement in stability under conditions of 90 TC and 30% RH.

### DETAILED DESCRIPTION OF THE EMBODIMENTS

The present invention is further described in detail below, through specific embodiments. One skilled in the art can understand the present invention more comprehensively through the following embodiments, which, however, do not limit the present invention in any way.

### Embodiment 1

(1) A solvent of commercial Nafion D521 dispersion is evaporated, to obtain Nafion polymer.

(2) The Nafion polymer and potassium ferrocyanide are physically mixed at a mass ratio of 95:5, to obtain a membrane formulation.

(3) The membrane formulation is dissolved in dimethylformamide to prepare a membrane casting solution with a total solute concentration of 100 g/L, and the solution is left to stand for defoaming.

(4) The membrane casting solution is decanted into a casting dish and evaporated for 20 h at the temperature of 80° C. and 1 atm pressure (ambient conditions) to form a membrane.

(5) After solvent evaporation and membrane formation process are complete, the membrane is removed from the casting dish and immersed in 1 M sulfuric acid in an ice bath environment for acidification, to obtain a proton exchange membrane with much improved chemical stability.

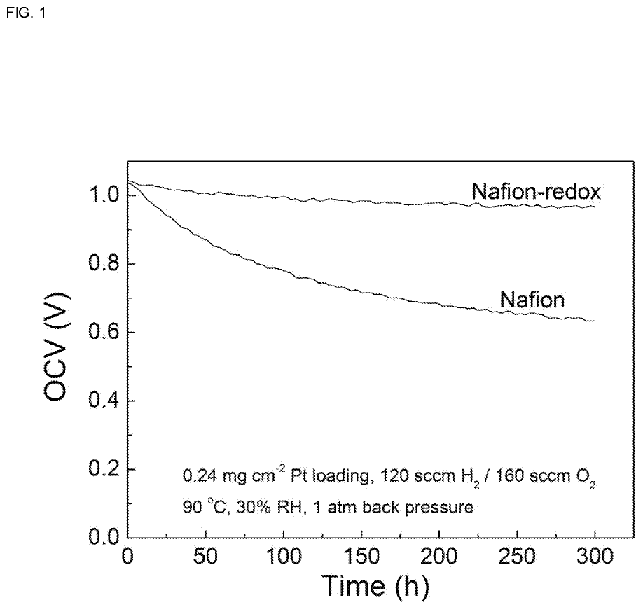

FIG. 1 shows the change of the open circuit voltage (OCV) value of a proton exchange membrane (Nafion-Redox) prepared in the embodiment 1 and a comparative proton exchange membrane (recast Nafion) prepared similarly by using only commercial Nafion solute, tested over time in the absence of operating current of the fuel cell. Before the OCV test, membranes were processed into membrane electrode assembly (MEA). Commercial Pt/C (60 wt % Pt, Johnson Matthey, England) was used as the catalyst for both anode and cathode. The catalysts were dispersed in Nafion binder (Nafion D521 dispersion, Alfa Aesar, China), where the mass ratio of Nafion to the catalyst was 20 wt %. The resulting dispersion was sprayed by an air gun (Iwata, Japan) onto carbon paper (Toray 250, Japan) to achieve 0.4 mg cm⁻² catalyst loadings (0.24 mg Pt cm⁻² ) on both anode and cathode with an effective area of 4 cm². MEA was fabricated from the anode-membrane-cathode sandwich by hot press under a pressure of 4.0 MPa at 120° C. for 3 min. The OCV testing environment is as follows: the anode hydrogen flow rate is 120 sccm, the cathode oxygen flow rate is 160 sccm, test temperature is 90° C., test humidity is 30% RH, and test back pressure is 1 atm. In conditions of elevated temperature, low humidity, and no operating current, a large number of free radicals are generated in the fuel cell, resulting in rapid chemical degradation of the proton exchange membrane. FIG. 1 shows that the open circuit voltage value of Nafion-Redox shows slight decline of 7.3% over a period of 300 h, while the open circuit voltage value of comparative recast Nafion decreases by 40% within 300 h. Test results of the open circuit voltage durability of the fuel cells prove that the addition of the redox reagent composed of ferricyanide or ferricyanide with a strong negative charge greatly improves the chemical stability of the recast commercial Nafion proton exchange membrane.

### Embodiment 2

(1) 10.0g of poly(ether ether ketone) is dissolved in 300 mL of concentrated sulfuric acid for a reaction for 60 h at room temperature. The obtained solution is poured into ice water, and a precipitate is washed with pure ice water until the pH value reaches 7.0. The recovered polymer is then dried for 12 h at room temperature, to obtain sulfonated poly(ether ether ketone) with a 70% degree of sulfonation.

(2) The sulfonated poly(ether ether ketone) and potassium ferricyanide are physically mixed at a mass ratio of 90:10 to obtain a membrane formulation.

(3) The membrane formulation is dissolved in dimethylacetamide to prepare a membrane casting solution with a total concentration of 50 g L⁻¹, and the solution is left to stand for defoaming and degassing.

(4) The membrane casting solution is decanted into a casting dish and evaporated for 12 h at the temperature of 120° C. under ambient 1 atm pressure conditions to form a membrane.

(5) After membrane formation is complete, the membrane is removed from the casting dish and immersed in 1 M sulfuric acid in an ice bath environment for acidification, to obtain a proton exchange membrane with much improved chemical stability.

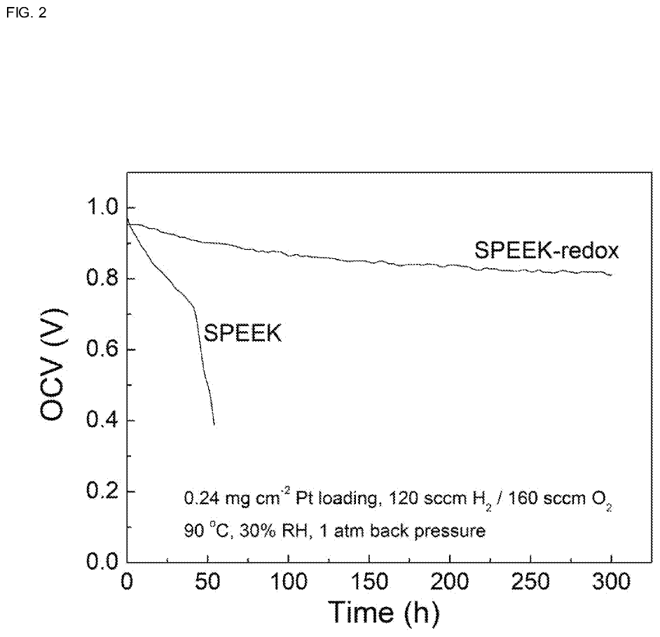

The proton exchange membrane (SPEEK-Redox) prepared by physically mixing the sulfonated poly(ether ether ketone) with redox stabilizer potassium ferricyanide in embodiment 2 and a comparative proton exchange membrane (SPEEK) prepared by using only the sulfonated poly(ether ether ketone) without redox stabilizer are assembled into fuel cells. Changes in the open circuit voltage value over time are tested in the absence of operating current of the fuel cell, with test conditions being the same as those in embodiment 1. FIG. 2 demonstrates that the open circuit voltage value of SPEEK-Redox decreases by about 15% within 300 h, while the open circuit voltage value of comparative SPEEK without redox stabilizer comes to a catastrophic damage within 55 h. Test results of the open circuit voltage durability of the fuel cells prove that redox stabilizer ferricyanide or ferricyanide compounds greatly improve the chemical stability of the SPEEK proton exchange membrane.

### Embodiment 3

(1) Commercial sulfonated polysulfone (SPSf) with 40% degree of sulfonation (Shandong Jinlan special polymer Co. Ltd, China) is dissolved in dimethylformamide, and the polymer solution is poured into water to precipitate purified sulfonated polysulfone.

(2) The sulfonated polysulfone and sodium pentacyanoferrate are physically mixed at a mass ratio of 99:1 to obtain a membrane formulation.

(3) The membrane formulation is dissolved in N-methylpyrrolidone to prepare a membrane casting solution with a total concentration of 500 g L⁻¹, and the solution is left to stand for defoaming.

(4) The membrane casting solution is decanted into a casting dish and evaporated for 48 h at a temperature of 20° C. under ambient conditions of 1 atm pressure to form a membrane.

(5) After membrane formation is complete, the membrane is removed from the casting dish and immersed in 1 M sulfuric acid in an ice bath environment for acidification, to obtain a proton exchange membrane with high chemical stability.

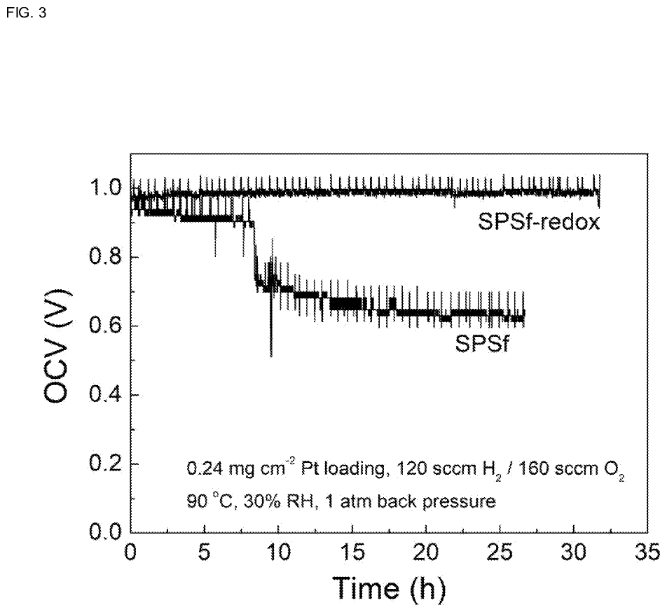

The proton exchange membrane (SPSf-Redox) prepared by physically mixing the sulfonated polysulfone and the sodium pentacyanoferrate in embodiment 3 and a comparative proton exchange membrane (SPSf) prepared by using only the sulfonated polysulfone are assembled into fuel cells. Changes in the open circuit voltage value over time are tested in the absence of operating current of the fuel cell, with test conditions being the same as those in embodiment 1. FIG. 3 shows that the open circuit voltage value of SPSf-Redox shows no decrease within 32 h, while the open circuit voltage value of comparative SPSf without redox stabilizer decreases by more than 30% within 27 h. Test results of the open circuit voltage durability of the fuel cells prove that the ferricyanide or ferricyanide redox stabilizers greatly improve the chemical stability of the SPSf proton exchange membrane.

### Embodiment 4

(1) Commercial sulfonated poly(ether sulfone) with 30% degree of sulfonation (YANJIN™ Technology Co. Ltd, China) is dissolved in dimethylformamide, and the polymer solution is poured into water to precipitate purified sulfonated poly(ether sulfone).

(2) The sulfonated poly(ether sulfone) and sodium pentacyanoferrate are physically mixed at a mass ratio of 97:3 to obtain a membrane formulation.

(3) The membrane formulation is dissolved in dimethyl sulfoxide to prepare a membrane casting solution with a total concentration of 300 g and the solution is left to stand for defoaming.

(4) The membrane casting solution is decanted into a casting dish and evaporated for 40 h at a temperature of 40° C. under ambient conditions of 1 atm pressure to form a membrane.

(5) After membrane formation process is complete, the membrane is removed from the casting dish and immersed in 1 M sulfuric acid in an ice bath environment for acidification, to obtain a proton exchange membrane with much improved chemical stability.

The proton exchange membrane prepared by physically mixing the sulfonated poly(ether sulfone) and the sodium pentacyanoferrate in embodiment 4 and a comparative proton exchange membrane prepared by using only sulfonated poly(ether sulfone) without redox stabilizer are assembled into fuel cells. Changes in the open circuit voltage value over time are tested in the absence of operating current of the fuel cell, with test conditions being the same as those in embodiment 1. The open circuit voltage value of the redox stabilized membrane decreases by about 3% within 300 h, while the open circuit voltage value of the membrane without redox stabilizer decreases by more than 40% within 120 h. Test results of open circuit voltage durability of the fuel cells prove that the negatively charged ferricyanide or ferricyanide redox stabilizer greatly improves the chemical stability of the poly(ether sulfone) proton exchange membrane.

### Example 5

(1) Following a reported synthetic procedure (Polymer 44 (2003) 4509-4518), 2.55 g of 3-(2′,4′-diaminophenoxy)propane sulfonic acid is dissolved in 21 mL of m-cresol and 2.76 mL of triethylamine, with stirring under nitrogen flow. Then 2.412 g of 1,4,5,8-naphthalenetetracarboxylic dianhydride and 1.56 g of benzoic acid are added. The mixture is heated to 80° C. for 6 h and then 180° C. for 30 h. After cooling to room temperature, additional 30 mL of m-cresol is added to dilute the highly viscous solution. The solution mixture is poured into acetone. The resulting precipitate is collected by filtration, washed with acetone, and dried for 12 h at a temperature of 30° C., to obtain sulfonated polyimide with a 100% degree of sulfonation.

(2) The sulfonated polyimide and potassium ferricyanide are physically mixed at a mass ratio of 98:2 to obtain a membrane formulation.

(3) The membrane formulation is dissolved in m-cresol to prepare a membrane casting solution with a total concentration of 200 g L⁻¹, and the solution is left to stand for defoaming.

(4) The membrane casting solution is decanted into a casting dish and evaporated for 48 h at a temperature of 20° C. under ambient conditions of 1 atm pressure to form a membrane.

(5) After the membrane formation is complete, the membrane is removed from the casting dish and immersed in 1 M sulfuric acid in an ice bath environment for acidification, to obtain a proton exchange membrane with much improved chemical stability.

The proton exchange membrane prepared by physically mixing the sulfonated polyimide and the potassium ferricyanide in embodiment 5 and a comparative proton exchange membrane prepared by using only the sulfonated polyimide are assembled into fuel cells. Changes in the open circuit voltage value over time are tested in the absence of operating current of the fuel cell, with test conditions being the same as those in embodiment 1. The open circuit voltage value of the redox stabilize sulfonate polyimide membrane decreases by about 8% within 500 h, while the open circuit voltage value of the non-redox-stabilized membrane decreases by more than 30% within 180 h. Test results of open circuit voltage durability of the fuel cells prove that the negatively charged ferricyanide or ferricyanide redox stabilizer greatly improves the chemical stability of the sulfonated polyimide proton exchange membrane.

### Embodiment 6

(1) 5.0 g of vinyl benzene and 5.0 g of a sodium vinylbenzenesulfonate monomer are dissolved in benzene, and 0.7 g of azobisisobutyronitrile is added as an initiator for free radical polymerization. The polymerization reaction is performed for 18 h at a temperature of 120° C. under the protection of nitrogen. The reaction solution is decanted into water to precipitate the resulting sulfonated polystyrene with a 35% degree of sulfonation.

(2) The sulfonated polystyrene and potassium ferrocyanide are physically mixed at a mass ratio of 91:9 to obtain a membrane formulation.

(3) The membrane formulation is dissolved in dimethylformamide to prepare a membrane preparation solution with a total concentration of 350 g L⁻¹, and the solution is left to stand for defoaming.

(4) The membrane casting solution is decanted into a casting dish and evaporated for 30 h at a temperature of 50° C. under ambient conditions of 1 atm pressure to form a membrane.

(5) After membrane formation is complete, the membrane is removed from the casting dish and immersed in 1 M sulfuric acid in an ice bath environment for acidification, to obtain a sulfonated polystyrene proton exchange membrane with much improved chemical stability.

The proton exchange membrane prepared by physically mixing the sulfonated polystyrene and potassium ferrocyanide redox stabilizer in embodiment 6 and a comparative proton exchange membrane prepared by using only the sulfonated polystyrene without redox stabilizer are assembled into fuel cells. Changes in the open circuit voltage value over time are tested in the absence of operating current of the fuel cell, with test conditions being the same as those in embodiment 1. The open circuit voltage value of the redox-stabilized membrane decreases by about 5% within 200 h, while an open circuit voltage value of the non-redox-stabilized membrane decreases by more than 50% within 90 h. Test results of the open circuit voltage durability of the fuel cells prove that the negatively charged ferricyanide or ferricyanide redox stabilizer greatly improves the chemical stability of the sulfonated polystyrene proton exchange membrane.

### Embodiment 7

(1) 10.0 g of vinyl pyridine monomer is dissolved in benzene, and 0.5 g of azobisisobutyronitrile is added as an initiator for free radical polymerization. The polymerization reaction is performed for 12 h at 100° C. under the protection of nitrogen. The reaction solution is decanted into water for precipitate the resulting poly(vinyl pyridine).

(2) 1.6 g of sodium pentacyanoferrate and 3.8 g of 15-crown-5 are dissolved in 10 mL of water. 0.4 g of the poly(vinyl pyridine) is dissolved in 10 mL of methanol. The two solutions are mixed for a reaction time of 1 h at a temperature of 40° C. The reaction solution is poured into water in an ice bath environment, and the resulting precipitate is washed with 1 M sulfuric acid, washed with isopropanol three times and then dried for 12 h at room temperature to obtain a product with a formula of

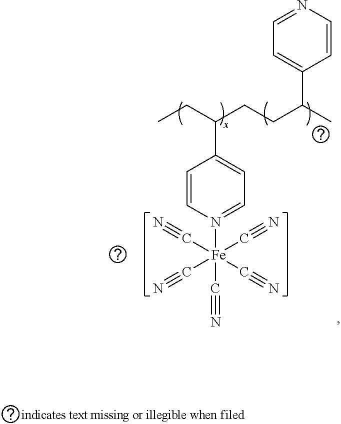

which is used as a proton-conducting membrane formulation, wherein the proportion x of modified chain segments is 70%. Here, the redox stabilizer is physically attached to the polymer chain, rather than simply being mixed.

(3) The membrane formulation is dissolved in methanol to prepare a membrane casting solution with a total concentration of 10 g and the solution is left to stand for defoaming.

(4) The membrane casting solution is decanted into a casting dish and evaporated for 42 h at a temperature of 30° C. under ambient conditions of 1 atm pressure to form a membrane.

(5) After a membrane formation process completed, the membrane is removed from the casting dish and immersed in 1 M sulfuric acid in an ice bath environment for acidification, to obtain a proton exchange membrane with much improved chemical stability.

The proton exchange membrane prepared by using the poly(vinyl pyridine) modified by the sodium pentacyanoferrate in embodiment 7 and a proton exchange membrane prepared by using unmodified poly(vinyl pyridine) are assembled into membrane electrode assemblies for fuel cell tests. Changes in the open circuit voltage value over time is tested in the absence of operating current of the fuel cell, with test conditions being the same as those in embodiment 1. The open circuit voltage value of the redox-stabilized membrane decreases by about 9% within 360 h, while the open circuit voltage value of the non-redox-stabilized membrane decreases by more than 55% within 60 h. Test results of the open circuit voltage durability of the fuel cells prove that the negatively charged ferricyanide or ferricyanide group greatly improves the chemical stability of the proton exchange membrane.

### Embodiment 8

(1) Commercial poly(vinyl chloride) is dissolved in tetrahydrofuran, and the polymer solution precipitation is precipitated into water to obtain purified poly(vinyl chloride).

(2) 5 g of purified poly(vinyl chloride) is reacted with 300 mL of a dimethylformamide solution of 0.5 g of sodium hydride and 5 g of p-hydroxypyridine for 2 h at a temperature of 0° C. The resulting reaction solution is decanted into water and dried for 12 h at a temperature of 30° C. to obtain a precursor polymer. 9.6 g of sodium pentacyanoferrate and 24.0 g of 15-crown-5 are dissolved in 50 mL of water. Separately, 1.0 g of the precursor polymer is dissolved in 50 mL of dimethylformamide. The two solutions are then mixed and reacted at a temperature of 40° C. for 8 h. The resulting reaction solution is poured into water, and the precipitate is washed with 1 M sulfuric acid three times, then washed with pure water until the pH value is 7. After recovering the polymer, it is then dried for 12 h at the temperature of 80° C. to obtain a product with the structural formula of

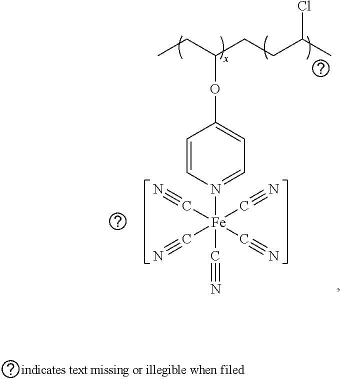

which is used as a proton-conducting membrane formulation, wherein the proportion x of modified chain segments is 35%.

(3) The membrane formulation is dissolved in tetrahydrofuran to prepare a membrane casting solution with a total concentration of 250 g L⁻¹ and the solution is left to stand for defoaming.

(4) The membrane casting solution is decanted into a casting dish and evaporated for 16 h at the temperature of 90° C. under ambient conditions of 1 atm pressure to form a membrane.

(5) After the membrane formation process is completed, the membrane is removed from the casting dish and immersed in 1 M sulfuric acid in an ice bath environment for acidification, to obtain a proton exchange membrane with high chemical stability.

The proton exchange membrane prepared by using the poly(vinyl chloride) modified by the sodium pentacyanoferrate in embodiment 8 and a comparative proton exchange membrane prepared by using unmodified poly(vinyl chloride) are assembled into fuel cells. Changes in the open circuit voltage value over time is tested in the absence of operating current of the fuel cell, with test conditions being the same as those in embodiment 1. The open circuit voltage value of the former membrane modified by the pentacyanoferrate decreases by about 5% within 400 h, while the open circuit voltage value of the latter membrane decreases by more than 32% within 150 h. Test results of open circuit voltage durability of the fuel cells prove that the negatively charged ferricyanide or ferricyanide group greatly improves the chemical stability of the proton exchange membrane.

### Embodiment 9

(1) 4.0 g of vinylidene fluoride and 6.0 g of hexafluoropropylene are dissolved in 100 mL of dimethylformamide, and 0.4 g of benzoyl peroxide is added as an initiator for free radical polymerization. The polymerization reaction is performed for 18 h at a temperature of 120° C. under the protection of nitrogen. The reaction solution is then decanted into water for precipitation to obtain a copolymer of vinylidene fluoride and hexafluoropropylene (FC2178).

(2) 3 g of FC2178 are reacted with 300 mL of a dimethylformamide solution of 0.1 g of sodium hydride and 1 g of p-hydroxypyridine at a temperature of 0° C. for 1 h. The resulting reaction solution is slowly poured into water and the resulting precipitate is dried at a temperature of 30° C. for 12 h to obtain a precursor polymer. 1.2 g of sodium pentacyanoferrate and 3.0 g of 15-crown-5 are dissolved in 10 mL of water. Separately, 1.0 g of the precursor polymer is dissolved in 10 mL of dimethylformamide. The two solutions are then mixed to allow reaction at the temperature of 50° C. for 6 h. The reaction solution is then slowly decanted into water, and the precipitate is washed with 1 M sulfuric acid three times, then washed with pure water until pH value is 7. After polymer recovery, it is then dried at the temperature of 80° C. for 12 h to obtain a product with the formula of

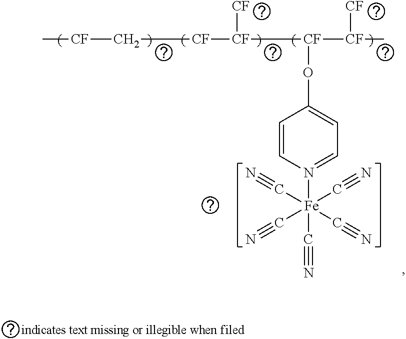

which is used as a proton-conducting membrane formulation, wherein the proportion x of modified chain segments is 1%.

(3) The membrane formulation is dissolved in dimethyl sulfoxide to prepare a membrane casting solution with a total concentration of 200 g and the solution is left to stand for defoaming.

(4) The membrane casting solution is decanted into a casting dish and evaporated at the temperature of 100° C. for 15 h under ambient conditions of 1 atm pressure to form a membrane.

(5) After the membrane formation process is completed, the membrane is taken out from the casting dish and immersed in 1 M sulfuric acid in an ice bath environment for acidification treatment, to obtain a proton exchange membrane with high chemical stability.

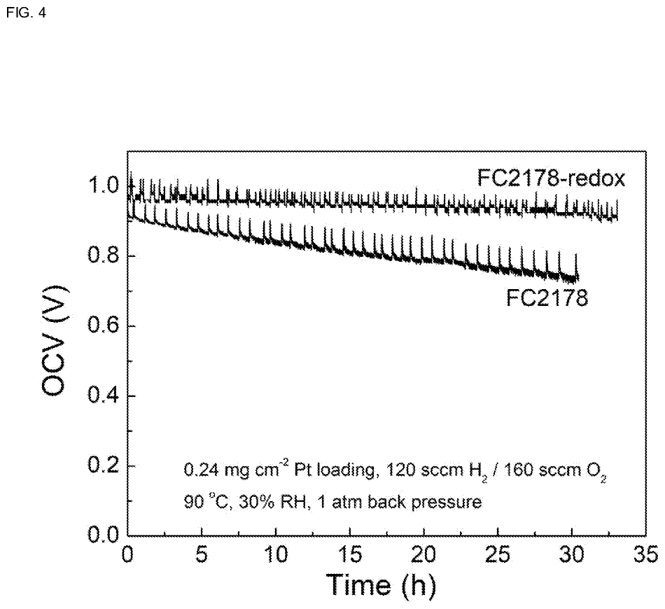

The proton exchange membrane prepared by using FC2178 which is modified by the sodium pentacyanoferrate pentacyanoammineferrate in embodiment 9 and a comparative proton exchange membrane prepared by using the unmodified FC2178 are assembled into fuel cells. Changes in the open-circuit voltage value over time is tested in the absence of operating current of the fuel cell, with test conditions being the same as those in embodiment 1. FIG. 4 shows that the open circuit voltage value of the former redox-stabilized membrane decreases by about 3% within 33 h, while the open circuit voltage value of the latter non-redox-stabilized membrane decreases by more than 12% within 30 h. Test results of open circuit voltage durability of the fuel cells prove that the negatively charged ferricyanide or ferricyanide group greatly improves the chemical stability of the proton exchange membrane.

Although the preferred embodiments of the present invention are described above in combination with the accompanying drawings, the present invention is not limited to the specific embodiments described above. The specific embodiments described above are merely for illustration rather than limitation. Inspired by the present invention, one skilled in the art may make many specific transformations without departing from the essence of the present invention and the protection scope of the claims, which, however, all fall into the protection scope of the present invention.

We claim:

1. A polymeric ion-conducting membrane with an enhanced stability against attacks of free radicals, comprising:
(a) a polymer matrix, and
(b) a redox stabilizer
wherein said redox stabilizer is attached to said polymer matrix by chemical or ligand bonding, or said redox stabilizer is physically mixed with said polymer matrix.

2. The polymeric ion-conducting membrane of claim 1, wherein said redox stabilizer is one or more molecules each independently comprising a ferrocyanide or a ferricyanide group.

3. The polymeric ion-conducting membrane of claim 2, wherein said molecule comprising a ferrocyanide or a ferricyanide group is selected from the group consisting of potassium ferrocyanide, sodium ferrocyanide, ammonium ferrocyanide, potassium ferricyanide, sodium ferricyanide, ammonium ferricyanide, hexacyanoferrous acid, hexacyanoferric acid, potassium nitroprusside, sodium nitroprusside, sodium pentacyanoammineferroate, and ammonium disodium pentacy anoammineferroate.

4. The polymeric ion-conducting membrane of claim 3, wherein said molecule comprises a ferrocyanide or a ferricyanide group is potassium ferricyanide or sodium pentacy anoammineferrate.

5. The polymeric ion-conducting membrane of claim 1, wherein said redox stabilizer is a hydroquinone-based molecule that undergoes a redox cycle.

6. The polymeric ion-conducting membrane of claim 5, wherein said is selected from the group consisting of hydroquinone, benzoquinone, naphthoquinone, phenanthraquinone, anthraquinone and all their related derivatives.

7. The polymeric ion-conducting membrane of claim 1, wherein said polymer matrix has a polymer chain architecture selected from the group consisting of homopolymer, random or block copolymer, random or block terpolymer, crosslinked polymer, interpenetrating network, and a polymer containing side chains.

8. A method of making a proton exchange membrane, comprising:
(a) preparing a polymer matrix;
(b) adding an amount of a redox stabilizer to said polymer matrix in a predetermined mass ratio to form a membrane formulation or, alternatively, attaching an amount of a redox stabilizer directly to said polymer matrix in a predetermined mass ratio by ligand or chemical bonding to from a modified polymer matrix;
(c) dissolving said membrane formulation or modified polymer matrix in a solvent to afford a membrane casting solution;
(d) casting said membrane casting solution and allowing the solvent evaporating therefrom to form a membrane; and
(e) conducting acidification of said membrane to obtain a proton exchange membrane.

9. The method of claim 7, wherein said redox stabilizer is a molecule comprising a ferricyanide or a ferricyanide group.

10. The method of claim 8, wherein said molecule comprising a ferrocyanide or a ferricyanide group is selected from the group consisting of potassium ferrocyanide, sodium ferrocyanide, ammonium ferrocyanide, potassium ferricyanide, sodium ferricyanide, ammonium ferricyanide, hexacyanoferrous acid, hexacyanoferric acid, potassium nitroprusside, sodium nitroprusside, sodium pentacyanoammineferroate, and ammonium disodium pentacyanoammineferroate.

11. The method of claim 7, wherein said redox stabilizer is a hydroquinone-based molecule that undergoes a redox cycle.

12. The method of claim 7, where said polymer matrix is prepared from one or more ingredients selected from the group consisting of Nafion, sulfonated poly(ether ether ketone), sulfonated polysulfone, sulfonated poly(ether sulfone), sulfonated polyimide, sulfonated polybenzimidazoles, sulfonated polystyrene, sulfonated polynitrile, sulfonated polyphenylenes, sulfonated poly(phenylene oxide)s, sulfonated polyphenylene sulfide, sulfonated polyphosphazene, poly(vinyl pyridine), poly(vinyl chloride), polytetrafluoroethylene, poly(vinylidene fluoride) and copolymers of vinylidene fluoride and hexafluoropropylene.

13. The method of claim 7, wherein in step(b) said predetermined mass ratio of polymer matrix to redox stabilizer is (99-85):(1-15)

14. The method of claim 13, wherein in step(c) said solvent is selected from the group consisting of dimethylformamide, dimethylacetamide, N-methylpyrrolidone, dimethyl sulfoxide, diphenyl ether, hexamethylphosphoramide, hexaethylphosphoramide, ethylene glycol monophenyl ether, triethylene glycol, diethylene glycol, dimethylbenzene, dimethylphenol, tetrahydrofuran, methyltetrahydrofuran and dioxane.

15. The method of claim 7, wherein said evaporation in step(d) is conducted at a temperature between 20 and 160° C. and a pressure between 0 and 1 atm.

16. The method of claim 7, wherein said acidification in step(e) is conducted in an acid selected from the group consisting of sulfuric acid, hydrochloric acid, nitric acid and acetic acid.
